(19) United States
(12) Patent Application Publication
(10) Pub. No.: US 2007/0120965 A1
(43) Pub. Date: May 31, 2007

(54) Mobile video teleconferencing authentication and management system and method

(76) Inventors: Roy Benjamin Sandberg, Huntington Beach, CA (US); Dan Ron Sandberg, San Francisco, CA (US)

Correspondence Address: Roy Sandberg;Apt. #B, 218 Knoxville Ave., Huntington Beach, CA, 92648, US

(21) Appl. No.: 11/287,035

(22) Filed: Nov. 25, 2005

(51) Int. Cl. H04N 7/14

(52) U.S. Cl. 348/14.08

(57) ABSTRACT

A mobile video teleconferencing system providing a means for customizing the access and control granted to each remote user of the system via a configurable database of access and control settings.

### BACKGROUND OF THE INVENTION

(1). Field of Invention

The present invention is related to the field of video teleconferencing, more specifically, the invention is a system for controlling access to a mobile, remotely controlled video teleconferencing system.

(2). Related Art

Portable video teleconferencing systems, such as that described in Janda (U.S. Pat. No. USD208634), have existed since the 1960s. The high costs of bandwidth and specialized equipment prevented widespread adoption for decades. The availability of inexpensive computers and broadband Internet access in the 1990s led to an explosion in the use of video teleconferencing. While video teleconferencing provides a more life-like user experience than phone teleconferencing, the inability of a user to move around in a remote location is still a serious limitation.

Mobile video teleconferencing robots allow a user to see, hear, and move around in a remote location. The ability to move around provides the user a much richer experience than conventional video teleconferencing because it is a closer approximation to actually being in the remote location. See co-pending application U.S. Pat. No. 11/223,675.

Mobile video teleconferencing systems raise unique security and access concerns. There are often two concurrent users of a mobile video teleconferencing device—the remote user who controls the device, and the local user who interacts with the device in its local environment. Both of these users expect some degree of control over the device. Furthermore, the number of concurrent users may exceed two in some instances. More than one remote user may share access to or control of the device. More than one local user may interact with the device, and in some instances, granting the local users varying degrees of access to and control over the device may be beneficial. Furthermore, any of these users may expect a degree of ownership over the device, and so any of them may desire the ability to control the degree of access and control granted to the others. There is no known method, system, or apparatus for managing the sometimes conflicting requirements of these various users.

More specifically, in some cases a remote user may wish to be granted control of the mobile video teleconferencing device without waiting for a local user to answer his call to the mobile video teleconferencing device. For example, a remote user may wish to login to a mobile video teleconferencing robot (“MVTD”) to survey his home or business for intruders afterhours, where there would be no local user present to answer the call. In other cases, a local user would want to maintain his privacy by preventing a remote user from logging in without his express permission. A system, method or apparatus to enable both of these modes of operation in the same device is not known to exist.

Another example of an access and control feature that is presently lacking in mobile video teleconferencing systems is the ability to restrict a remote user to a specific geographic region. For example, a MVTD that is used in a store might be configured to allow management level remote users to have access to the backstock area, whereas customers would be geographically limited to the publically-accessible shopping area. A system, method or apparatus enabling this functionality is not known to exist.

Yet another useful access and control feature is the ability for a local or remote user to validate another before that user is granted the right to full use of the MVTD. This is useful when an unknown user attempts to login to an MVTD, and the person managing access to the MVTD wishes to verify that they may be trusted with the use of the MVTD before granting them access. A system, method or apparatus enabling this functionality is not known to exist.

When an MVTD is intended to be used by multiple users—either concurrently or sequentially—it is useful to be able to grant each user varying abilities to use the MVTD For example, some users may be granted the ability to move the MVTD, while other users may only see and hear what is transpiring at the remote location. This would be useful during a concurrent use if the MVTD was being used to give a remote “tour” of a facility to a group of people, only one of whom was controlling the movement of the MVTD. A sequential use scenario would occur when one user is not permitted to hear any conversations for security reasons, whereas another user who has the proper security clearance is permitted to hear the conversations that occur around him.

In some cases, granting a hierarchy of control rights to different users is also useful. For example, a MVTD trusted user might wish to override the actions of a malicious MVTD user by taking control of the MVTD away from the malicious user.

Another inventive area disclosed herein concerns the docking station. An MVTD will often have a docking station where it can be driven to be recharged. Known MVTDs do not computationally react to the presence of a docking station, thereby limiting a MVTD administrator's ability to simplify administration of the MVTD.

Finally, known MVTD's do not message potential users and administators upon the occurence of various events. This limits the utility of the MVTD.

In summary, related art mobile video teleconferencing systems do not permit each user's access and control rights to be customized, and they do not permit the mobile video teleconferencing device to be customized for its intended use.

### SUMMARY OF THE INVENTION

Definitions

The following terms shall be understood to be used as defined below in both the detailed description and the claims section of this document.

An MVTD right is a Boolean, scalar, or multidimensional software parameter representing the degree of usability the remote user has over a particular aspect of the MVTD such as its video camera, microphone, speaker, screen, movement subsystem, or any other individually controllable or accessible aspect of the MVTD.

An MVTD functionality is the actual, present ability of the remote user to use a certain aspect of the MVTD such as its video camera, microphone, speaker, screen, movement subsystem, or any other individually controllable or accessible aspect of the MVTD, as limited by an associated right.

Introduction

The present invention is a new and improved mobile video teleconferencing authentication and management system, which overcomes the many disadvantages inherent in the related mobile video teleconferencing systems. By storing access and control parameters in a database, each user of a MVTD may be accorded the appropriate degree of access and control.

There is no presently known consumer oriented, general-purpose commercial mobile video teleconferencing system. Due to the many possible use cases for such a device, a means of configuring the device to best suit the needs of each application and user is required.

The present invention is designed to enable a user to configure a commercial mobile video teleconferencing system to support a number of different use cases and users, as will be discussed below.

Mobile video teleconferencing is fundamentally different than the telephone or fixed video teleconferencing because the remote user may wish to assume control over the device without requiring any interaction from a local user. For example, a MVTD user may wish to log into the device in her home to make sure her iron is unplugged. If she had to wait for someone to “answer”, the MVTD would be useless for this purpose. On the other hand, a MVTD that supports login by a remote user without interaction from a local user creates a privacy concern for a local user. A means to correctly configure the MVTD for both of these scenarios is required.

Furthermore, some applications may require a mobile video teleconferencing device with restricted access to its environment. In some cases, supervision may be required before a remote user is allowed to control the movement of the device.

By providing a means for customizing the access and control granted to each remote user of the MVTD, this invention allows the device to be customized to properly reflect a balance between security and control best reflecting the needs of each particular application and user.

More specifically, in some cases a remote user may wish to be granted control of the mobile video teleconferencing device without waiting for a local user to answer his call to the mobile video teleconferencing device. For example, a remote user may wish to login to an MVTD to survey his home or business for intruders afterhours, where there would be no local user present to answer the call. In other cases, a local user may want to maintain his privacy by preventing a remote user from logging in without his express permission. This invention provides a means to support both modes of operation within the same device. Additionally, some embodiments of the invention support a hardware mechanism that makes it more difficult to circumvent the privacy granted a local user when the device is placed in that mode.

A computer system implementing this capability can be created through the use of a video teleconferencing device that includes a computational device. A call answer switch accessible to the computational device may be used to answer incoming video teleconferencing calls. A Boolean variable accessible to the computational device is used to store a call answering mode value. If the Boolean variable is true, a remote user cannot initiate a video teleconferencing call without a local user actuating the call answer switch. However, if the Boolean variable is false, the remote user may initiate a video teleconferencing call without a local user actuating the call answer switch. Thus, the boolean variable determines the mode of operation of the device.

The invention also includes the ability to restrict a remote user to a specific geographic region. For example, a MVTD that is used in a store might be configured to allow management level remote users to have access to the backstock area, whereas customers would be geographically limited to the publically-accessible shopping area. The invention includes implementations of this idea based on GPS, proximity sensors and beacons, as well as other means of geographic location known in the art.

A computer system implementing this capability can be implemented using a mobile video teleconferencing device that includes a video camera, a movement control system, and a computer. A position-locating device, typically placed on the MVTD, is used to determine the present location of the mobile video teleconferencing device. Position locating devices can include GPS, proximity sensors, or other means known in the art to determine a position. Movement can be constrained to a specific region by an administrator or other user, program, or device that enters a specific geographic area into the computer. The computer then runs software that constrains the movement control system based on input accepted from the position-locating device. By this mechanism, a mobile video teleconferencing device can be prevented from leaving the geographic area that has been delimited.

Yet another useful access and control feature is the ability for a local or remote user to validate another before that user is granted the right to full use of the MVTD. This is useful when an unknown user attempts to login to an MVTD, and a person managing access to the MVTD (either the local user or another remote user) wishes to verify that the unknown user may be trusted with the use of the MVTD before granting him access. The invention supports a variety of different validation formats, including validation by a local user and validation by a remote user. Furthermore, different combinations of access rights may be granted to a remote user before and after validation, as best befits the particular usage model.

This feature can be implemented in a broad fashion on a mobile video teleconferencing device that includes a video camera, a movement control system, and a computer. The computer must determine a set of one or more initial MVTD rights used to limit the remote user's ability to use MVTD functionalities. The computer also determines a set of one or more alternate MVTD rights, also used to limit the remote user's ability to use MVTD functionalities. A caller validation switch is connected such that its switch state is accessible to the computer. Following actuation of the caller validation switch, the computer replaces the set of initial MVTD rights with the set of alternate MVTD rights as the set of rights that limit the remote user's ability to use MVTD functionalities. If, for example, the initial MVTD rights are defined to be the right of the remote user to appear on the MVTD video display, and the alternate rights are defined to be the right of the remote user to view the video stream sent by the MVTD camera, then a validation scheme has been implemented that prevents the remote user from seeing the local user until after the local user validates him by actuating the caller validation switch. Other combinations of initial and alternate MVTD rights are also possible. As a generalization, validation will often require that the alternate MVTD rights consist of the initial rights plus at least one additional right, where the alternate rights provide a greater functionality to a remote user than the initial rights.

When an MVTD is intended to be used by multiple users—either concurrently or sequentially—it is useful to be able to grant each user varying abilities to use the MVTD. For example, some users may be granted the ability to move the MVTD, while other users may only see and hear what is transpiring at the remote location. This would be useful if the MVTD was being used to give a remote “tour” of a facility to a group of people, only one of whom was controlling the movement of the MVTD. This feature is also supported by this invention.

A general method of granting one set of rights independently of the granting of another set of rights can be implemented using a computational device which may be part of the mobile video teleconferencing device. The computational device would be programmed to limit a remote user's first MVTD functionality according to a first MVTD right, and to limit a remote user's second MVTD functionality according to a second MVTD right.

A more specific implementation of this method consists of giving a user the ability to access the video stream without being able to control the movement of the device. This consists of an implementation where the first MVTD right is a Boolean video access parameter specifying whether a remote user may obtain a video stream from a video camera on the mobile video teleconferencing device, and the second MVTD right is a Boolean motion control parameter specifying whether a remote user may control movement of the mobile video teleconferencing device. Furthermore, the first MVTD functionality is obtaining a video stream from a video camera on the mobile video teleconferencing device, and the second MVTD functionality is controlling movement of the mobile video teleconferencing device. This would, for example, allow some users to see the video stream being sent by the device, whereas others would be able to move the device as well.

Another specific implementation of this method consists of defining the first MVTD right as a Boolean video display parameter specifying whether a remote user may display a video stream on the mobile video teleconferencing device from a remote video camera, the remote video camera collocated with the remote user, and defining the second MVTD right as a Boolean video access parameter specifying whether the remote user may obtain a video stream from a video camera on the mobile video teleconferencing device. Furthermore, the first MVTD functionality is displaying a video stream from a remote video camera, the remote video camera collocated with the remote user, and the video stream displayed on the mobile video teleconferencing device, and the second MVTD functionality is obtaining a video stream from a video camera on the mobile video teleconferencing device. This would, for example, allow some users to see the video stream being sent by the device, whereas other others would not be able to see the video, but would instead be visible on the device themselves. Other variations of differing functionalities granted to two or more MVTD users are also possible, and would be apparent to a person of ordinary skill in the art.

In some cases, granting a heirarchy of control rights to different concurrent users is also useful. For example, a MVTD trusted user might wish to override the actions of a malicious MVTD user by taking control of the MVTD away from the malicious user. The invention allows some users to override the actions of other users. In other cases, a user may “barge-in” to an MVTD that is already being controlled and take over control from the user who is already controlling the MVTD.

This may be implemented using a mobile video teleconferencing device comprising a video camera, a movement control system, and a computer. A remote user access granter, a software construct executing on the computer, grants a first remote user access to the mobile video teleconferencing device. The remote access granter also grants a second remote user access to the mobile video teleconferencing device. Thus, the first remote user and second remote user may simultaneously access one or more subsystems of the mobile video teleconferencing device.

A more specific example exists where a hierarchy of user permissions exists, defining which rights are accessible to which users. Another more specific example occurs when the second remote user can override the actions of the first remote user. The subsystems can be further defined to include a video camera, a video screen, a microphone, a speaker, and a movement control system.

An MVTD will often have a docking station where it can be driven to be recharged. The invention includes various ways of reacting to the presence of a docking station. For example, the invention includes automatically disconnecting the current call when the MVTD first enters the docking station. This is similar to how a conventional landline phone terminates the call when it is placed into the phone craddle. This feature is useful as a means to simplify the usage of the MVTD in cases when an analogy to a standard phone call is appropriate. The invention also includes cases where a remote user attempts to drive the MVTD out of its docking station before the MVTD's batteries are sufficiently charged. In this case, an event may be issued to deal with this occurance. For example, the MVTD may disable the motors, thereby preventing the user from removing the MVTD from the docking station. Alternatively, the MVTD may send a message to either the remote user or a 3^{rd} party informing that person that the MVTD is being used while insufficiently charged. Other events based on removal from the docking station are also possible.

A general implementation of this idea includes a mobile video teleconferencing device comprising a video camera, a movement control system, and a computer. Additionally, a docking station that permits docking with the mobile video teleconferencing device is also required. A docking station attached sensor, attached to either the docking station or the mobile video teleconferencing device, detects whether or not the docking station is attached to the mobile video teleconferencing device. The docking station attached sensor causes a docked event in the computer when the mobile video teleconferencing device becomes docked and causes a not docked event in the computer when the mobile video teleconferencing device becomes not docked. This allows the mobile video teleconferencing device to computationally react to the docking.

One possible computational reaction to a docking event is to disconnect any ongoing call. Additionally, with the addition of a battery life sensor that detects a low battery condition, and causes a low battery state in the computer, another specific computational reaction is possible. With this configuration, an attempt to use the motion control subsystem to remove the mobile video teleconferencing device from the docking station during a low battery state would result in the execution of a preprogrammed event.

A number of preprogrammed events are possible. One in particular is the temporary disabling of the movement control subsystem until the low battery state has ended. Another possible preprogrammed event is the sending of a message to the remote user.

The MVTD may message potential users and administators upon the occurence of various events. For example, the MVTD may message the remote user and/or an administrator when the remote user ends the call before docking the MVTD. This increases the likelihood that the MVTD will be charged when it is not in use. In other cases, a remote user and/or 3^{rd} party may be messaged when the battery is low. This allows the remote user or adminstrator to take appropriate action before the batteries run out (such as docking the MVTD). The MVTD may also notify a 3^{rd} party when the current call ends. This may be useful when one or more users is waiting to use an MVTD that is already in use.

This feature may be implemented using a mobile video teleconferencing device comprising a video camera, a movement control system, and a computer. A notification module, executing on the computer, is able to notify an address through the Internet. This address is notified of an event.

A more specific implementation requires a docking station attached sensor, which is used to detect whether or not the docking station is attached to the mobile video teleconferencing device. In this implementation, the notification module notifies an address when the docking station attached sensor shows that the mobile video teleconferencing device is not docked, and a mobile video teleconferencing call has just ended.

Another more specific implementation requires a battery life sensor that detects a low battery condition. In this implementation the notification module notifies an address when the battery life sensor shows a low battery condition.

Finally, in another more specific implementation the notification module notifies an address when the present call has been terminated.

An additional feature concerning access and control of the MVTD is the ability to initiate a call from the MVTD to a remote user as specified by a local user. This allows the MVTD to operate as a regular video teleconferencing device, in addition to its use as a remotely controllable mobile platform.

### DETAILED DESCRIPTION OF THE DRAWINGS

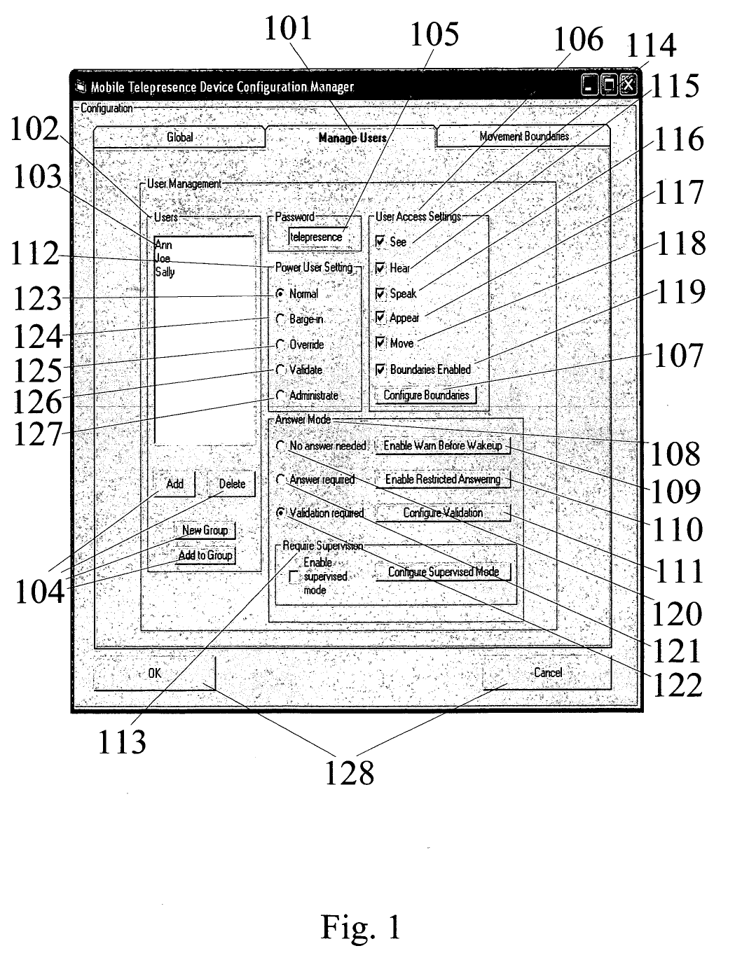

FIG. 1 is a graphical user interface detailing the user-oriented configuration options for a mobile video teleconferencing system.

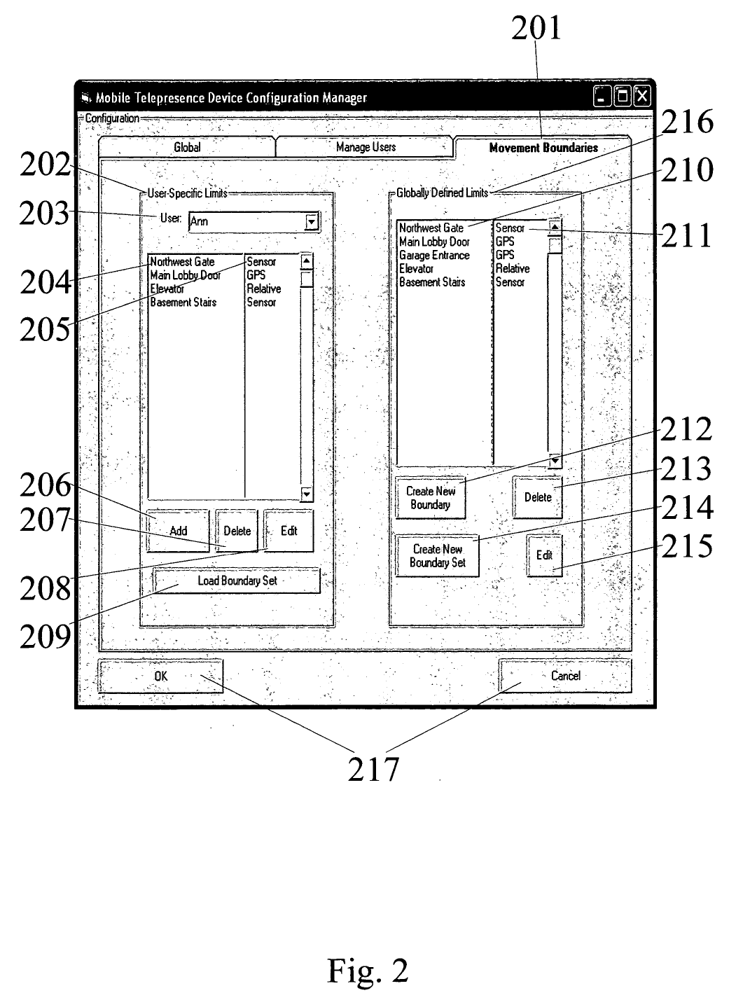

FIG. 2 is a graphical user interface detailing the movement boundary selection options for a mobile video teleconferencing system.

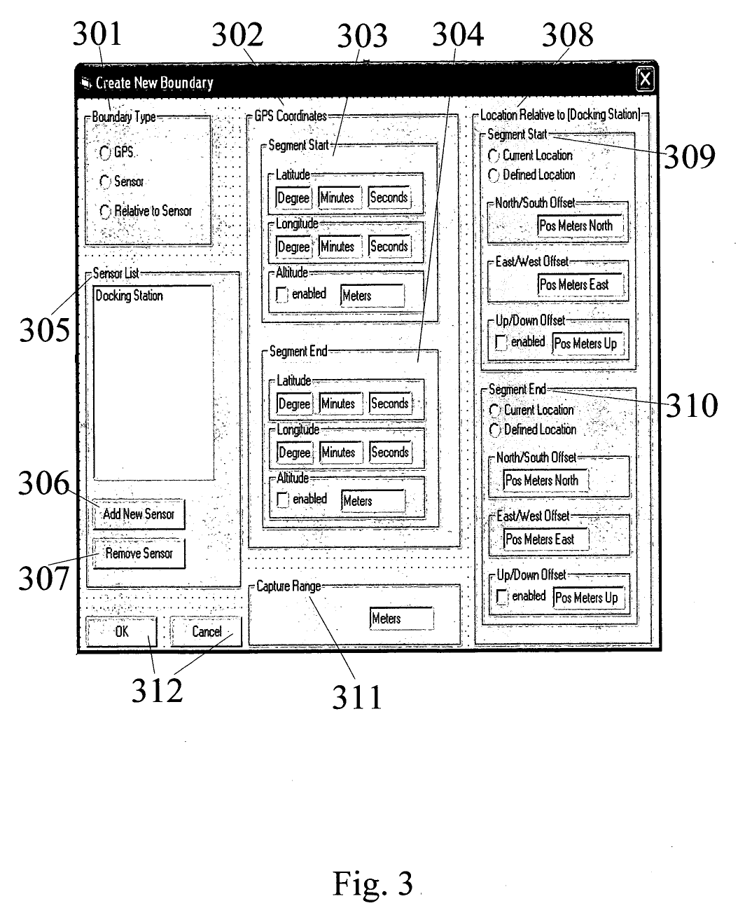

FIG. 3 is a graphical user interface detailing the movement boundary creation options for a mobile video teleconferencing system.

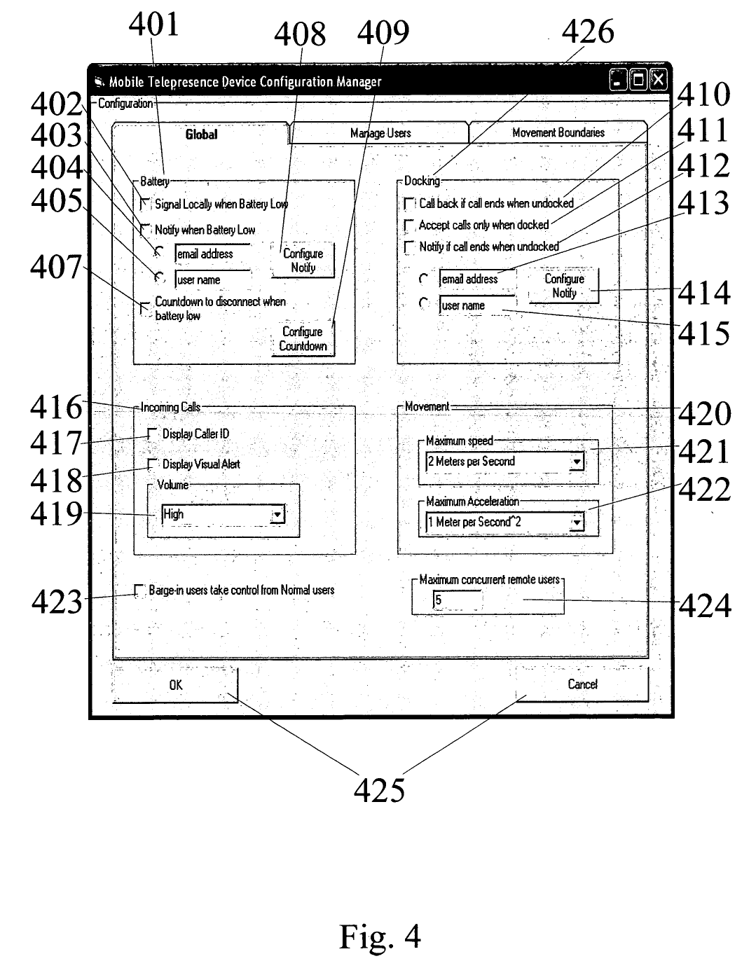

FIG. 4 is a graphical user interface detailing the global configuration options for a mobile video teleconferencing system.

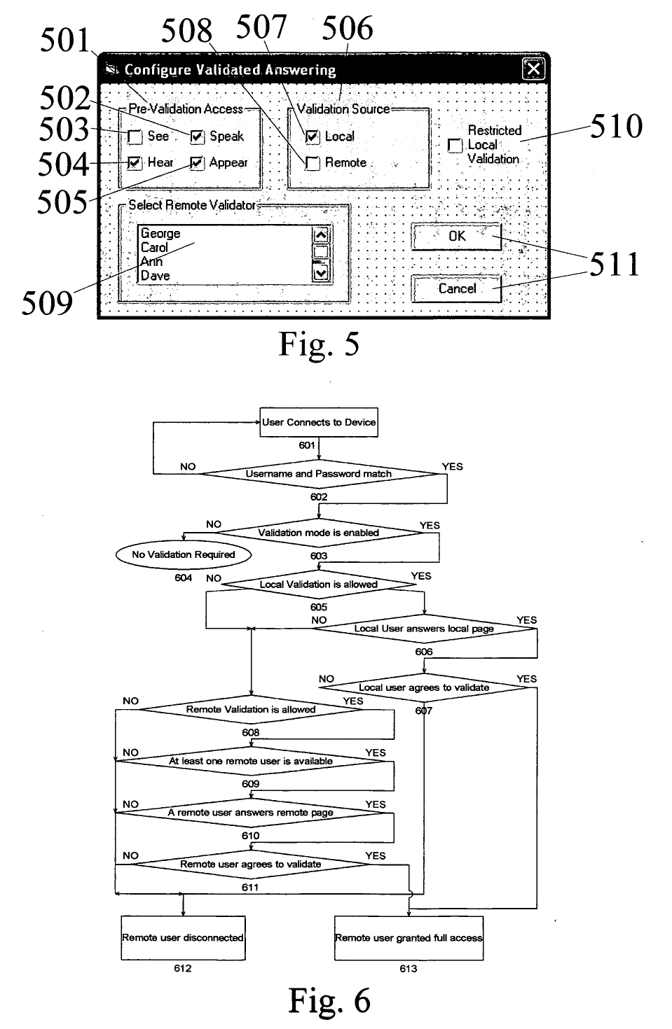

FIG. 5 is a graphical user interface detailing the validated user-answering feature for a mobile video teleconferencing system.

FIG. 6 is a flow chart detailing the validate user feature.

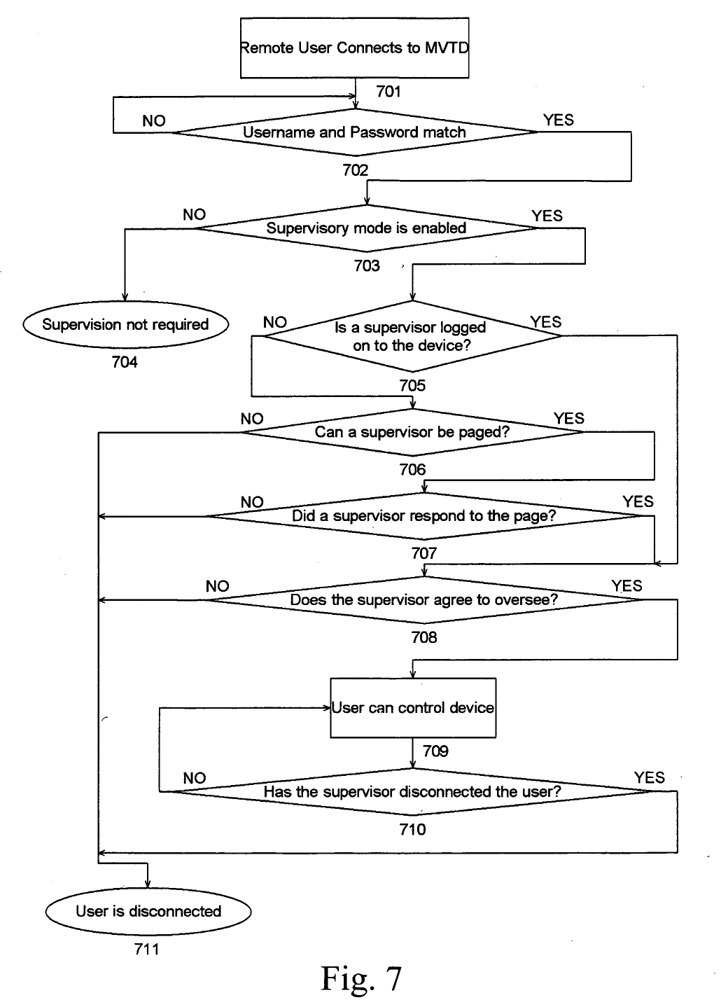

FIG. 7 is a flow chart detailing the supervise mode feature.

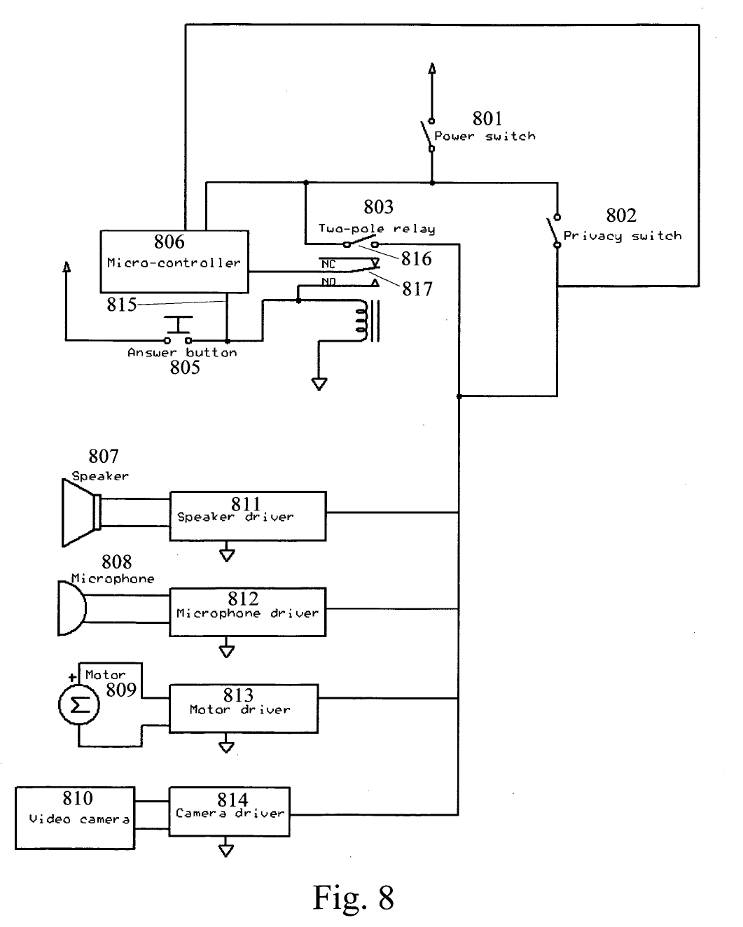

FIG. 8 is a schematic detailing the privacy mode switch.

### DETAILED DESCRIPTION OF THE INVENTION

The present invention is a new and improved mobile video teleconferencing authentication, control and management system, which overcomes the many disadvantages inherent in the related video teleconferencing systems.

FIG. 1 is a graphical user interface detailing the user-oriented configuration options for a mobile video teleconferencing system. A manage users tabbed interface 101 controls aspects of configuring the device related to user-based settings. A user list section 102 controls creation, management and deletion of users. A list of current users 103 shows users that have already been defined. Via the add, delete, new group, and add to group buttons 104 new users may be added, existing users may be deleted, groupings of users may be defined, and existing users may be added as members of a group.

Each user is associated with a password 105 that is provided by an administrator. Alternate identification methods may be used, such as public/private key authentication, token-based authentication, bio-informatic identification, and other identification methods known in the art.

The degree to which each user has physical control over the device is configured in the user access settings frame 106. Checking “see” 114 enables the remote user to receive a video stream from the MVTD. Checking “hear” 115 enables the remote user to receive an audio stream from the MVTD. Checking “speak” 116 enables the remote user to send an audio stream to the MVTD that is then played through the device's speaker. Checking “appear” 117 enables the remote user to send a video stream to the MVTD that is displayed on the device's monitor. Checking “move” 118 enables the remote user to control movement of the remote device, alter the angle of the device's tilt mechanism, and manipulate any actuators the device may have. In alternative embodiments, each form of movement may be individually selected and controlled. Selecting the boundaries enabled checkbox 119 limits the allowable motion of the device to defined region. The configure boundaries button 107 is used to define this region, and the effect of pressing this button will be discussed below.

The answer mode frame 108 controls how the MVTD accepts an incoming connection request. If no answer needed 120 is selected, the device merely queries an incoming user for their username and password. Alternate identification methods may be used, such as public/private key authentication, token-based authentication, bio-informatic identification, and other identification methods known in the art. If this information is correctly given, the user is granted access to the system. Enable Warn Before Wakeup mode 109 causes the MVTD to ring and/or display a visual cue for a predefined time before granting access to the remote user. This alerts local users that a remote user will soon be controlling the device, thereby preventing them from being startled by the remote user. If answer required 121 is selected, the MVTD begins to ring and/or display a visual cue. Much like a phone, this cue will continue for a predetermined time until the device is “answered” by a local user who must press the appropriate button on the MVTD to accept the call.

A remote user may also answer the call if he has been empowered to do so. Enabling restricted answering 110 restricts the local and remote users who can answer to those that have the proper password or key. Alternate identification methods may be used, such as public/private key authentication, token-based authentication, bio-informatic identification, and other identification methods known in the art. If validation required answering 122 is selected, the call must be answered as in the “answer required” case, but additionally, the remote user who is calling is limited to some restricted set of capabilities until his identity is verified. This is typically used in concert with an anonymous login, where the remote user's identity is verified (visually and/or through voice confirmation) before he is granted the ability to move the MVTD or see through the MVTD's camera. The degree of access granted to the remote user before validation can be configured 111. For example, some remote users may only be able to appear for visual confirmation, whereas other users may be able to see and speak as well, but not be able to move until they have been validated. Furthermore, only some local or remote users may be granted the right to validate a given remote user.

The power user settings frame 112 controls the degree of control the remote user is granted with respect to other remote users. A normal user 123 is not granted any special abilities over other users. However, whereas a normal user may not connect to an MVTD already hosting a remote user, a user with barge-in level 124 abilities can connect to an MVTD despite the fact that it is already in use. This is useful when one remote user wishes to act as a “tour-guide” for another user or users. By coupling barge-in level access with a user access setting that does not include “move”, a user can watch, and hear what is happening, but cannot control the actions of the MVTD. In the preferred embodiment, two or more remote users with “speak” access can simultaneously speak through the MVTD speaker if they are both connected, and two or more users with “appear” access will appear simultaneously on the MVTD screen.

A user with override level ability 125 can control the device despite the capabilities of other users concurrently using the device. In the preferred embodiment, a hierarchy of access rights exist. An “override” capable user also has all the abilities of a “barge-in” capable user. This means that an override user can log in and assume control of the device when, for example, the current user is not following instructions or is otherwise abusing the rights granted to him. A user with validate abilities 126 has all the capabilities of an override-level user, with the added capability of being able to remotely validate users that are limited to “validate required” 122 answering. Finally, a remote user with administrate abilities 127 has all the abilities of a validate-level user, but in addition, has full access to all configuration information, and can change the capabilities, access, and other settings of other users. An administrate-level user is a super-user who can control all aspects of the MVTD system that can be altered remotely. Non-hierarchical as well as more fine-grained access rights are also possible in alternative embodiments.

Enabling the require supervision mode 113, alters the given user's access to the MVTD such that he can only use MVTD functionality when another user is monitoring his actions. This user is typically a remote user with at least override level abilities, but in principal any user may be selected to be a supervisor, including a local user.

The standard OK and Cancel buttons 128 are used to accept or ignore any changes made to the user management settings.

FIG. 2 is a graphical user interface detailing the movement boundary selection options for a mobile video teleconferencing system. Movement boundaries are used to restrict the range of movement of a particular user. A group of users may also be defined to be a user, and thus the term “user” should be taken to mean an individual user or a group of users. This is useful to keep users within a prescribed zone. For example, it may be desirable to keep a user on a particular property, or away from stairwells or other potential hazards. The movement boundaries tab 201 contains configuration options for selecting movement boundaries for each user.

Movement boundaries are associated with a particular user in the user-specific limits frame 202. The user to which the movement boundaries should apply is selected from the user combo box 203. A list of boundaries that apply to each selected user is displayed in the boundary list box 204. The type of boundary is listed in the boundary type list box 205. A new boundary may be associated with a particular user by using the add button 206. Boundaries that have been associated with a particular user may be removed with the delete button 207. Characteristics of a particular boundary may be altered with the edit button 208. Predefined sets of boundaries may be loaded using the load boundary set button 209.

User-specific limits are selected from a pool of globally defined limits 216. The list of all defined movement boundaries is displayed in the globally defined limits list box 210. The type of boundary for each limit is listed in the global boundary type list box 211. New boundaries are created with the create new boundary button 212. Existing global movement boundaries are deleted using the delete button 213. A grouping of global boundaries may be created using the create new boundary set button 214. Global boundaries are a useful set of boundaries that are expected to be used in many user profiles. For example, a series of boundaries marking the perimeter of a warehouse may be grouped together if many users will have their movements limited to the warehouse. Existing globally defined movement limits may be edited by use of the edit button 215. The standard OK and Cancel buttons 217 are used to accept or ignore any changes made to the movement boundary settings.

FIG. 3 is a graphical user interface detailing the movement boundary creation options for a mobile video teleconferencing system. To create a new movement boundary, first the type of movement boundary must be selected in the Boundary Type frame 301. GPS-based movement boundaries rely on data from the Global Positioning System to ascertain the current position of the MVTD. Sensor-based movement boundaries rely on proximity sensors placed within the environment the MVTD is being used. Alternatively, a sensor on the MVTD may detect an external beacon. These sensors and/or beacons can be used to ascertain when the MVTD moves outside of a specified zone. Relative positioning uses relative positioning data stored by the MVTD to determine the MVTD's current position relative to a known marker. Typically, sensors or the docking station will be used as known markers.

If GPS-based boundaries are selected, then a boundary must be defined using GPS coordinates. One method is by defining a line segment composed of a starting GPS coordinate and an ending GPS coordinate 302. The starting GPS coordinate 303 is entered as a latitude, longitude, and optional altitude. Similarly, the ending coordinate 304 is also entered as a latitude, longitude and optional altitude.

If sensor-based boundaries are selected, then the sensor that will be used must be added. Sensors are either proximity-based devices, that trigger when the MVTD gets close, or breaks a beam, or distance-based devices, where the MVTD can determine how far from the sensor it is. A group of these can be used for position triangulation. Sensors that have been added are listed in the sensor list box 305. Adding new sensors is accomplished with the add new sensor button 306. Sensors can be removed from the sensor list with the remove sensor button 307.

If relative positioning is used, optional movement sensors on the MVTD are used to calculate the distance and direction it has moved from a known location, such as the docking station. This method is not very accurate, but can be useful to constrain the range of the MVTD if no other means are available. First a sensor must be selected from the sensor list 305 to be the relative positioning home location. A boundary is then defined by defining a start and end location for a line segment. The start of the segment 309 may be either the MVTD's current location, as determined by its current on-board relative position sensors, or a user-defined location. A user-defined location consists of an offset from the home position, defined as the distance in the north-south direction from the sensor as well as the distance in the east-west direction from the sensor. An optional up-down offset from the sensor may also be used, but requires an on-board altimeter or other means of detecting the current height of the MVTD. For example, a sensor may be placed on each floor, thereby allowing the MVTD to determine what floor it is currently on. The end of the line segment 310 is similarly configured.

In general, it may be desirable to increase the range in which the MVTD responds to a predefined boundary. The capture range frame 311 allows the boundary to extend by a specified amount in directions. This alters the geometry of the boundary from a line segment to a shape approximating a cylinder with the original line segment at its center.

The standard OK and Cancel buttons 312 are used to accept or ignore any changes made to the newly created boundary settings.

FIG. 4 is a graphical user interface detailing the global configuration options for a mobile video teleconferencing system. The battery frame 401 contains configuration options relating to battery life. The MVTD may optionally signal local users (via visual and auditory means) that its battery is low 402. In addition, the MVTD may notify a remote party that the battery is low 403. This is useful when there is an administrator that oversees the MVTD, and who is responsible for making sure it is returned to the docking station before its charge runs out. The remote party can be contacted either by email 404, or by the MVTD initiating a session with a user 405. Further configuration of the notify function is achieved through the configure notify button 408. The MVTD can also be programmed to automatically disconnect current users when the battery gets low. The specifics concerning the countdown before a user is disconnected, and the types of users whom the disconnect applies to can be configured with the configure countdown button 409.

The MVTD must be docked with its docking station in order to charged. Therefore, it may be useful to require users to dock the MVTD before they disconnect. Towards this end, the “call back if call ends when undocked” option 410, serves as a means to alert forgetful users of their obligation to dock the MVTD. Similarly, a third party may be alerted if a call ends while the MVTD is not docked 412. This party may be notified by email 413, or by having the MVTD initiate a call with the party 415. Other configuration options for this feature can be configured with the configure notify button 414. In some cases, it may be useful to only accept calls when the MVTD is docked. For example, the MVTD may be docked near a receptionist, and if calls only originate when the device is docked, the receptionist can validate the identity of all incoming callers. This option is available with the accept calls only when docked option 411. The configure notify button 414 is also used to figure this feature. In particular, a list of users or user types who may call even when the MVTD is not docked may be specified.

Global configuration options concerning incoming calls are handled in the incoming calls frame 416. Incoming calls may display the callers ID when they “ring” 417. A visual alert may optionally accompany the auditory alert 418. The volume of the auditory alert may be adjusted 419.

Global movement parameters may be specified in the movement frame 420. The devices maximum speed may be configured 421. Additionally the maximum acceleration may be specified 422.

Barge-in users may optionally take control from normal users that are already logged in 423. The maximum number of concurrent remote users may be specified 424.

The standard OK and Cancel buttons 425 are used to accept or ignore any changes made to the global settings.

FIG. 5 is a graphical user interface detailing the validated user-answering feature for a mobile video teleconferencing system. The pre-validation frame 501, allows the access granted to a user before validation to be selected. The user may be granted Speak 502, See 503, Hear 504, or Appear 505 access. The remote user may be validated either by a local user, or by another remote user. The validation source frame 506 allows configuration of these preferences. Selecting local 507 causes the MVTD to prompt local users to validate the remote user. Selecting remote 508 causes the MVTD to contact the specified remote user-validators, requesting that they validate the user. One or more remote user-validators that are authorized to validate the remote user may be selected from the select remote validator list box 509. If both the local and remote check boxes are selected, the device first attempts to query a local user, and if the local user does not respond in time, the remote users will be contacted. In alternative embodiments, the remote user-validator may be contacted first, or both remote and local validators may be contacted simultaneously, with the first to respond being responsible for validating the remote user. An another alternative embodiment, the user may specify the order in which validators are contacted. If the restricted local validation check box 510 is selected, only local users that are authorized may validate a remote user. Authorization may be managed with a password, key, or other means of restricting access known in the art. The standard OK and Cancel buttons 511 are used to accept or ignore any changes.

FIG. 6 is a flow chart detailing the validate user feature. A user begins by connecting to the device 601. The MVTD prompts the user for a name and password 602. If an unknown name and password is entered, the user is queried again. Alternate identification methods may be used, such as public/private key authentication, token-based authentication, bio-informatic identification, and other identification methods known in the art. If the name and password match, then the user's record is queried to determine if validation mode should be enabled 603. If validation is not required 604, then no further action is required with respect to the validate user feature. If validation mode is enabled, then the device queries the user's record to see if local validation is enabled 605. If local validation is not enabled, the device queries the user's record to determine if remote validation is enabled 608. If local validation is enabled, the MVTD pages the local user 606. If a local user-validator does not answer within a specified time, the device moves on to remote validation 608, below. If the local user-validator answers within the specified time, and agrees to validate the remote user, then the remote user is granted full access to the device 613. If the local user-validator does not agree to validate, the remote user is disconnected 612. In an alterative embodiment, the remote user may also seek validation from a remote user-validator even if the local user does not validate him. In yet another alternative embodiment, the remote user will be locked out of the MVTD for some specified time, thereby preventing continuous attempts to be validated if initially denied validation. The device also checks if remote validation is allowed 608. If remote validation is not allowed, the remote user is disconnected 612. If remote validation is allowed, the list of allowable remote user-validators is checked to ascertain if at least one remote user-validator is available to be paged 609. If none are available, the remote user is disconnected 612. If at least one remote user-validator is available to be paged, one of these user-validators is paged, and the device waits for a response 610. If a remote user-validator does not answer the page, then other remote user-validators may optionally be contacted. If none of the user-validators answers the page, then the remote user is disconnected 612. If one of the remote user-validators answers the page, then that user-validator is queried as to whether they wish to validate the remote user 611. If the remote user-validator agrees to validate, then the remote user is granted full access 613. If the remote user-validator does not agree to validate, then the remote user is disconnected 612. In an alternative embodiment, the remote user will be locked out of the MVTD for some specified time, thereby preventing continues attempts to be validated if initially denied validation.

FIG. 7 is a flow chart detailing the supervise mode feature. The remote user begins by connecting to the MVTD 701. The remote user first must enter a matching username and password 702. Alternate identification methods may be used, such as public/private key authentication, token-based authentication, bio-informatic identification, and other identification methods known in the art. If the username and password pair is not found in the MVTD database, then the remote user is prompted to reenter the username and password. If the username and password match, the MVTD determines if supervisory mode is enabled 703. If it is not, then no further action is required with respect to the supervise mode feature 704. If supervisory mode is enabled, then the MVTD must determine if a remote user-supervisor is logged onto the device 705. If no remote user-supervisor is present, then the device must determine if a supervisor can be paged 706. In the preferred embodiment, a list of possible remote user-supervisors is associated with each remote user, and their availability status is tracked. Only available remote user-supervisors are considered available to be paged. In alternative embodiments, the pool of remote users requiring supervision shares an overall list of available remote user-supervisors. If no remote user-supervisors are available to be paged, the remote user is disconnected 711. If at least one user-supervisor is available to be paged, each of those user-supervisors is paged via some algorithm, in the preferred embodiment, the remote user-supervisors are ranked in order of preference, and each of the user-supervisors is paged in that order. In an alternative embodiment, all available user-supervisors are paged simultaneously, and the first to respond is granted supervisor status for the remote user. If none of the available user-supervisors respond to the page 707, then the remote user is disconnected 711. If at least one user-supervisor does respond to the page 707, or if a remote user-supervisor is already logged on to the device 705, then the user-supervisor is queried whether they are willing to oversee the remote user 708. If they do not, the remote user is disconnected 711. If they agree to supervise, the remote user can control the device 709. At any point during the remote user's use of the device, the supervisor-user can disconnect the user 710. Additionally, should the supervisor-user intentionally or inadvertently log out of the MVTD, the remote user will be disconnected. This ensures that remote users are always supervised, and that their actions do not go unattended.

FIG. 8 is a schematic detailing the privacy mode switch. Overall power to the entire MVTD device is controlled through the power switch 801. The privacy switch 802 is used to prevent a remote user from accessing the speaker 807, microphone 808, drive motors 809, and camera 810. This would be done when it is desirable to leave the device on, and to allow users to login, but to prevent them from using the device without a local user's authorization. The privacy switch is implemented in hardware using a design that cannot be overridden in software, thereby assuring a local user's privacy even if the MVTD software is maliciously altered. Incoming calls are answered using the answer push button 805. Pressing the answer push button 805 sends a signal to the microcontroller 806 via an input 815. The answer push button 805 also activates a relay 803. If a microcontroller output 817 is active, the relay 803 stays in the latched position, and supplies power through the second pole 816 to the speaker driver 811, microphone driver 812, motor driver 813, and camera driver 814. By this means, even if the privacy switch is activated, power to these subsystems is provided if the local user chooses to answer an incoming call. Upon call termination, the microcontroller 806 can be used to unlatch the relay 803, thereby de-powering those same subsystems. Because the microcontroller 806 depends on the answer button 805 to activate the relay, it can only be used to unlatch, not to latch, the relay 803. This prevents malicious software from overriding the effect of the privacy switch.

Advantages

What has been described is a new and improved mobile video teleconferencing authentication and management system overcoming the many disadvantages of related video teleconferencing systems.

By providing a means for customizing the access and control granted to each remote user of the MVTD, this invention allows the device to be customized to properly reflect a balance between security and control best reflecting the needs of each particular application and user. By allowing a user to selectably require or not require incoming calls to be answered, the invention overcomes previous mobile video teleconferencing solutions that did not account for usage in situations where a local user wishes to answer incoming calls as well as situations where a local user need not answer the call. By allowing each user varying degrees of access to sensory data such as the camera, speaker, display, and microphones, the invention enables a MVTD to be customized according to the requirements of each user and remote environment. By supporting two stage answering, the device enables unknown users to establish their trustworthiness before they are allowed full control over the device. By allowing multiple concurrent users to control the MVTD using a specified hierarchy, a variety of usage modes are enabled. For example, a remote user may be supervised while still being granted control over the motion of the MVTD. Also, multiple remote users can see and communicate with local users, but control of the MVTD can be limited to one of the remote users. Finally, a super-user can barge-in and takeover the MVTD when a remote user is improperly controlling the MVTD. By using geographic zone limits, movement of the MVTD can be confined to safe or restricted areas. For example, the MVTD can be prevented from driving down a flight of stairs. Alternatively, the MVTD can be prevented from entering private or restricted areas such as restrooms in a building.

A series of twelve use cases follow in order to familiarize the reader with a number of scenarios the inventors feel the invention is particularly suited to.

### EXAMPLE APPLICATION #1

A consumer buys an MVTD and places it in his house so that he can check that everything is fine in the house. For example, he might check that his pet has food and water, and that the oven was turned off. He calls the MVTD and logs in with the ‘admin’ username and password. This username and password combination is configured to grant the user full access rights. Upon logging in he has full access to see, hear, and control the MVTD. The consumer need not wait for a local user to answer the MVTD in this scenario.

### EXAMPLE APPLICATION #2

A manager buys an MVTD so that she can monitor the performance of her employees at a factory. Having the MVTD give a warning (visual and/or audible) that it is about to begin seeing/hearing would be appropriate in most cases, as this would lessen the feeling among the employees that he is spying on them. This could be enforced at the hardware level to make employees more at ease. The same effect can also be easily realized by keeping the docking station far from the employees to be watched. This would be analogous to the regular situation between employee and employer, where the employee usually has warning that the employer is on her way.

### EXAMPLE APPLICATION #3

Alice wants to video teleconference with her mobility-impaired friend Lara. She connects to the MVTD from her terminal, which then causes the MVTD to give Lara a visual and/or audible signal that someone is trying to connect. Optionally, the MVTD also signals the identity of the person requesting a video teleconference. Lara remotely accepts the ‘call’ through a remote answering device, similar to a remote control. This device could also show the identity of the caller. This device could also allow Lara to speak to and/or hear the caller. Alice, having been granted full control by Lara is able to steer the MVTD to Lara's location, where they are able to speak and see each other.

### EXAMPLE APPLICATION #4

Alice wants to video teleconference with her friend Lara. Alice connects to the MVTD, which then gives a visual and/or audible signal that someone is trying to connect. Lara's apartment is a mess and she doesn't want Alice to see it. Instead of pressing the ‘Answer’ button Lara presses the ‘Special Answer’ button thereby letting her specify that she would like to grant see and hear access rather than the usual see, hear, and move access. This ensures that Alice sees only what Lara wants her to see, because Alice can't move the MVTD.

### EXAMPLE APPLICATION #5

Lara receives a call from Dave, who is unknown to her. Lara doesn't want Dave to see or hear her since she knows nothing about him. Dave is a member of the ‘unknown’ group, because he has no corresponding record in the MVTD user database. Because Dave is in the unknown group, he is configured for two-stage answering. When Lara answers she can hear and see Dave but he cannot see or hear her. When Lara answers, Dave is notified that Lara has answered the call. He then describes why he is calling Lara. Lara, satisfied with his reasons for calling, gives him see and hear access permanently. Dave's future calls will no longer require two-stage answering, since he is now known to Lara.

### EXAMPLE APPLICATION #6

Dave wants to see what his daughter Lara is doing in preschool. Dave calls into the MVTD that is located in Lara's school. The MVTD signals that it is receiving a call through an audible and/or visual signal (possibly through a remote device). Since children cannot be trusted to know who should be given access to the MVTD, it is imperative that only a trusted user can answer the call. By using a device such as a physical key on the MVTD, a password inputted into the touch screen, or a remote answering device, a trusted local user is able to answer the call. Authentication now proceeds as in example #5. At the discretion of the preschool, the MVTD could be configured to not require future authentication (or answering) for future calls from Dave.

### EXAMPLE APPLICATION #7

Dave, located in California, calls real-estate agent Frank (also in California) to see what houses are for sale in Florida. Frank, knowing that he can trust Dave (or trusting him because he was vouch-safed by an acquaintance or by a third party trust organization) gives Dave full control of a group of MVTDs located in different houses in Florida. Dave is now able to tour the insides of different homes to see which ones meet his needs. Using an interface on his local computer, he can choose which MVTD to inhabit from a list. Frank can grant the access as one-time only, permanent, or grant it for some limited period of time.

### EXAMPLE APPLICATION #8

Dave, located in California, calls travel agent George in New York to look at different hotel options for his Hawaii honeymoon. George, having no reason to trust Dave gives him supervised full control of a MVTD in Hawaii. This supervision gives George the same permissions (See, Hear, and Move) that Dave has, with the ability to override or terminate Dave's control. Thus, even if Dave is malicious, George can prevent any damage from being done.

### EXAMPLE APPLICATION #9

Victor decides he wants to remotely visit his grandfather in the hospital. Victor connects to the hospital MVTD. Because he is not in the MVTD database, he is a member of the unknown group. The MVTD produces an audio and/or video signal informing local users of an incoming call. A boy tries to answer the call but cannot since he doesn't have the key. A nurse comes by and answers the device. He recognizes Victor and grants him full access. Victor now drives the MVTD to visit his grandfather.

Victor is supposed to drive the MVTD back to its base but forgets. Yuri tries to call the MVTD but is unable to connect to it because it has been set such that incoming calls are not allowed when it is not docked. This prevents patients having to deal with incoming calls when the MVTD is in their room undocked. The MVTD calls Victor back to remind him that he should dock the MVTD, but Victor is unreachable. The nurse is contacted but she is busy and forgets to drive the MVTD to its dock. The battery gets low and the MVTD therefore calls the nurse twice in a ten-minute period. The nurse doesn't respond. The MVTD now signals its low battery twice over the course of five minutes. The grandfather is alarmed but is not able to help. The MVTD batteries die and it is no longer functional. Alternatively, the MVTD can enter a ‘sleep mode’ whereby its power consumption is drastically cut. This mode could involve the CPU/network running at reduced power, or the CPU/network sleeping but waking up at a given interval to see if it has been called.

### EXAMPLE APPLICATION #10

The administrative user is in control of a MVTD at a school play. Harry and Irene connect to the MVTD. Because the administrator has already connected, and because Harry and Irene are allowed to have See and Hear access with permission from the administrator, they are able to watch and listen to the school play. Only the administrator is allowed to move the MVTD.

### EXAMPLE APPLICATION #11

Multiple MVTDs are being used to view a sporting event. A user, Jake, has been given See and Hear access to all of them. He may watch the event from the vantage of any of the MVTDs, or through a combination of them, where they are all visible using a split screen option on his local terminal.

### EXAMPLE APPLICATION #12

Karen wants to attend a class at her university remotely. She connects to the MVTD server, which assigns her to the MVTD closest to her classroom. She steers the MVTD to her class and is able to virtually attend.

While certain exemplary embodiments and examples have been described in detail and shown in the accompanying drawings, it is to be understood that such embodiments are merely illustrative of and not restrictive on the broad invention, and that this invention is not to be limited to the specific arrangements and constructions shown and described, since various other modifications may occur to those with ordinary skill in the art.

What is claimed:

1. A computer system for managing access to a video teleconferencing device, comprising:
(a) A video teleconferencing device comprising a computational device;
(b) a call answer switch, the call answer switch state accessible to the computational device, whereby incoming video teleconferencing calls are answered; and
(c) a Boolean state retainer, which may be physical or logical, for storing a call answering mode value, wherein
if the Boolean state retainer is true, a video teleconferencing call cannot be initiated by a remote user without a local user actuating the call answer switch, and
if the Boolean state retainer is false, a video teleconferencing call may be initiated by the remote user without the local user actuating the call answer switch.

2. The computer system of claim one, wherein:
if the Boolean state retainer is true, a physical circuit is opened, thereby degrading or disabling video teleconferencing calls.

3. A computer system for managing access to a mobile video teleconferencing device, comprising:
(a) a mobile video teleconferencing device comprising
(i) a video camera,
(ii) a movement control system, and
(iii) a computer;
(b) a locater, determining the present location of the mobile video teleconferencing device;
(c) a delimiter, enabling an administrator to delimit a geographic area; and
(d) a movement restricter, executing on the computer, the movement restricter accepting input from the locater, and constraining the movement control system, whereby the mobile video teleconferencing device is prevented from leaving the geographic area delimited by the delimiter.

4. The system of claim 3, wherein:
the locater determines the present location of the mobile video teleconferencing device using a global positioning system.

5. The system of claim 3 wherein:
the locater determines the present location of the mobile video teleconferencing device using proximity sensors.

6. A system for managing access to a mobile video teleconferencing device, comprising:
(a) a mobile video teleconferencing device comprising
(i) a video camera,
(ii) a movement control system, and
(iii) a computer;
(b) a set of one or more initial MVTD rights computationally determined by the computer, the initial MVTD rights used to limit the remote user's ability to use MVTD functionalities;
(c) a set of one or more alternate MVTD rights computationally determined by the computer, the alternate MVTD rights used to limit the remote user's ability to use MVTD functionalities; and
(d) a caller validation switch, the caller validation switch state accessible to the computer,
whereby actuating the caller validation switch results in the computer replacing the set of initial MVTD rights with the set of alternate MVTD rights as the set of rights that limit the remote user's ability to use MVTD functionalities;

7. The system of claim 6, wherein:
The alternate MVTD rights consist of the initial rights plus at least one additional right, the alternate rights providing greater functionality to a remote user than the initial rights.

8. The system of claim 6, wherein:
the initial MVTD rights include the right of the remote user to appear on the MVTD video display, and
the alternate MVTD rights include the right of the remote user to view the video stream sent by the MVTD camera.

9. A method for restricting access to a mobile video teleconferencing device using a computational device which may be part of the mobile video teleconferencing device, comprising:
(a) limiting a remote user's first MVTD functionality according to a first MVTD right; and
(b) limiting a remote user's second MVTD functionality according to a second MVTD right;

10. The method of claim 9 wherein:
(a) the first MVTD right is a Boolean video access parameter specifying whether a remote user may obtain a video stream from a video camera on the mobile video teleconferencing device;
(b) the second MVTD right is a Boolean motion control parameter specifying whether a remote user may control movement of the mobile video teleconferencing device;
(c) the first MVTD functionality is obtaining a video stream from a video camera on the mobile video teleconferencing device; and
(d) the second MVTD functionality is controlling movement of the mobile video teleconferencing device.

11. The method of claim 9 wherein:
(a) the first MVTD right is a Boolean video display parameter specifying whether a remote user may display a video stream on the mobile video teleconferencing device from a remote video camera, the remote video camera collocated with the remote user;
(b) the second MVTD right is a Boolean video access parameter specifying whether the remote user may obtain a video stream from a video camera on the mobile video teleconferencing device;
(c) the first MVTD functionality is displaying a video stream from a remote video camera, the remote video camera collocated with the remote user, and the video stream displayed on the mobile video teleconferencing device; and
(d) the second MVTD functionality is obtaining a video stream from a video camera on the mobile video teleconferencing device.

12. A system for managing access to a mobile video teleconferencing device, comprising:
(a) a mobile video teleconferencing device comprising
(i) a video camera,
(ii) a movement control system, and
(iii) a computer;
(b) a remote user access granter, executing on the computer, granting a first remote user access to the mobile video teleconferencing device, and the remote access granter, granting a second remote user access to the mobile video teleconferencing device, wherein
the first remote user and second remote user may simultaneously access one or more subsystems of the mobile video teleconferencing device.

13. The system of claim 12 wherein:
a hierarchy of user permissions exists, defining which rights are accessible to which users;

14. The system of claim 12 wherein:
the second remote user can override the actions of the first remote user.

15. The method of claim 12 wherein:
the subsystems comprise a video camera, a video screen, a microphone, a speaker, and a movement control system.

16. A computer system for managing access to a video teleconferencing device, comprising:
(a) a mobile video teleconferencing device comprising
(i) a video camera,
(ii) a movement control system, and
(iii) a computer;
(b) a docking station, the docking station permitting docking with the mobile video teleconferencing device;
(c) a docking station attached sensor, attached to either the docking station or the mobile video teleconferencing device, detecting whether or not the docking station is attached to the mobile video teleconferencing device, and causing a docked event in the computer when the mobile video teleconferencing device becomes docked and causing a not docked event in the computer when the mobile video teleconferencing device becomes not docked, thereby
allowing the mobile video teleconferencing device to computationally react to the docking.

17. The system of claim 16, wherein:
the mobile video teleconferencing device reacts by disconnecting any ongoing call upon the computer detecting the docked event.

18. The system of claim 16, further comprising:
a battery life sensor, the battery life sensor detecting a low battery condition, and causing a low battery state in the computer,
whereby an attempt to use the motion control subsystem to remove the mobile video teleconferencing device from the docking station during a low battery state results in the execution of a preprogrammed event.

19. The system of claim 18, wherein:
The preprogrammed event is the temporary disabling of the movement control subsystem until the low battery state has ended.

20. The system of claim 18, wherein:
The preprogrammed event is the sending of a message to a remote user.

21. A computer system for managing access to a video teleconferencing device, comprising:
(a) a mobile video teleconferencing device comprising
(i) a video camera,
(ii) a movement control system, and
(iii) a computer;
(b) a notification module, executing on the computer, the notification module able to notify an address through the Internet, whereby the address is notified of an event.

22. The system of claim 21, further comprising:
a docking station attached sensor, the docking station attached sensor detecting whether or not the docking station is attached to the mobile video teleconferencing device; and
the notification module notifying an address when the docking station attached sensor shows that the mobile video teleconferencing device is not docked, and a mobile video teleconferencing call has just ended.

23. The system of claim 21, further comprising:
a battery life sensor, the battery life sensor detecting a low battery condition; and
the notification module notifying an address when the battery life sensor shows a low battery condition.

24. The system of claim 21, wherein:
the notification module notifies an address when a present call has been terminated.
